(19) United States
(12) Patent Application Publication
(10) Pub. No.: US 2026/0054788 A1
(43) Pub. Date: Feb. 26, 2026

(54) DRIVING ROBOT

(71) Applicant: LG ELECTRONICS INC., Seoul (KR)

(72) Inventors: Moonchan KIM, Seoul (KR); Iljae LEE, Seoul (KR); Gunho LEE, Seoul (KR); Wondong LEE, Seoul (KR); Sanghun MUN, Seoul (KR); Woojin KIM, Seoul (KR)

(73) Assignee: LG ELECTRONICS INC., Seoul (KR)

(21) Appl. No.: 19/105,697

(22) PCT Filed: Aug. 25, 2022
(86) PCT No.: PCT/KR2022/012736

§ 371 Date: Feb. 21, 2025

(51) Int. Cl. B62D 63/04; B25J 11/00; B60L 50/60; B62D 33/02

(52) U.S. Cl. CPC B62D 63/04; B25J 11/008; B60L 50/60; B62D 33/02

(57) ABSTRACT

A driving robot comprises: a lower housing; a frame assembly positioned inside the lower housing; a driving part positioned under the frame assembly; a battery coupled to the frame assembly; a substrate module coupled to the frame assembly and positioned above the battery; a LiDAR coupled to the front of the frame assembly; and a speaker module disposed adjacent to the LiDAR, wherein the lower housing includes: a groove portion that extends in the left and right directions on the front side and is recessed in the rear direction; a first opening formed in the groove and exposing the LiDAR; and a second opening positioned in front of the speaker module. As the driving robot includes various types of storage units, utilization may be improved.

### TECHNICAL FIELD

The present disclosure relates to a driving robot with a simple assembly and disassembly structure, easy maintenance, and rational space utilization of a mounting space.

### BACKGROUND

To take charge of a portion of factory automation, robots have been developed for industrial use. Recently, fields of application of the robots have been further expanding, and not only a medical robot and an aerospace robot, but also a robot that may be used in a daily life are being developed.

Such robot for the daily life is being developed to provide a specific service (e.g., shopping, serving, conversation, cleaning, and the like) in response to a user command. Unlike the industrial robot that performs repetitive tasks by being fixed at a specific location or a robot that performs a specific specialized function at a high cost, such as the medical or aerospace robots, travel and communication functions are important for the robot for the daily life and the robot for the daily life is difficult to be distributed when a manufacturing cost thereof is too high.

In particular, because the robot does not walk on two feet like humans but moves using wheels, the robot must be able to move over a bump on the floor or avoid an obstacle, must be able to minimize impact without falling when moving over the bump on the floor, and must be able to make quick decisions using multiple sensors to avoid the obstacle.

One that has been actively developed recently as an example of such a robot is a serving robot that may transport a bowl containing liquid food such as noodle or soup. The bowl containing the food may be put on a tray equipped in the robot and the robot may transport the food to a customer or a service provider.

A driving robot that transports food is mainly used indoors, but there is a risk of food spilling or malfunctioning resulted from a collision with an obstacle, so that a situation in which the robot needs to be disassembled for repair occurs. In this regard, when disassembly and reassembly are difficult, maintenance time may be long and functions may not operate properly.

### SUMMARY

### Technical Problem

The present disclosure is to provide a driving robot with a simple assembly and disassembly structure, easy maintenance, and rational space utilization of a mounting space.

### Technical Solutions

Provided is a driving robot including a lower housing, a frame assembly positioned inside the lower housing, a driving structure positioned under the frame assembly, a battery coupled to the frame assembly, a substrate module coupled to the frame assembly and positioned above the battery, a Lidar coupled to a portion in front of the frame assembly, and a speaker module disposed adjacent to the Lidar, wherein the lower housing includes a groove defined at a front side of the lower housing to extend in a left and right direction, wherein the groove is concavely recessed rearward, a first opening defined in the groove and exposing the Lidar, and a second opening located in front of the speaker module.

The driving structure may include a caster housing coupled to the frame assembly and having an open bottom, and a caster positioned in the caster housing, and the speaker may be positioned on a top surface of the caster housing.

The second opening may be obliquely inclined upward.

The driving robot may further include a sound guide inclined surface located at a front surface of the second opening, wherein the sound guide inclined surface is disposed at a lower portion of the groove to be inclined downward in an inward direction.

The driving robot may further include a third opening defined in a top surface of the groove, and a dissipation fan formed inside the third opening.

The groove may be recessed into a front surface of the lower housing by at least ⅓ of a length in a front and rear direction of the lower housing.

The driving robot may further include a pair of tray frames coupled to an upper portion of the lower housing and extending upward, and a tray module coupled to the tray frame.

The driving robot may further include a slide basket inserted between the tray module and the lower housing.

The driving robot may further include a scratch prevention rib protruding on at least one of a bottom surface of the slide basket and a top surface of the lower housing.

The driving robot may further include a camera box protruding from a front portion of a top surface of the lower housing, the pair of tray frames may be located on left and right sides of the slide basket, and the slide basket may have a handle formed at a rear surface thereof.

The driving robot may further include a head frame connecting upper ends of the pair of tray frames to each other, and an upper basket formed at the head frame.

The driving robot may further include a display located on a front surface of the upper basket.

According to another aspect of the present disclosure, provided is a driving robot including a lower housing, a frame assembly positioned inside the lower housing, a driving structure positioned under the frame assembly, a battery coupled to the frame assembly, a substrate module coupled to the frame assembly and positioned above the battery, a pair of tray frames coupled to an upper portion of the lower housing and extending upward, a tray module coupled to the tray frames, and a slide basket inserted between the tray module and the lower housing.

The driving robot may further include a scratch prevention rib protruding on at least one of a bottom surface of the slide basket and a top surface of the lower housing.

The driving robot may further include a camera box protruding from a front portion of a top surface of the lower housing, the pair of tray frames may be located on left and right sides of the slide basket, and the slide basket may have a handle formed at a rear surface thereof.

The driving robot may further include a head frame connecting upper ends of the pair of tray frames to each other; and an upper basket formed at the head frame.

### Advantageous Effects

The driving robot of the present disclosure includes various types of storages, so that usability may be improved.

In addition, the components with weak waterproofness may be disposed in the groove to minimize the water inflow.

Because the hole for the placement of the speaker or for the heat dissipation is not exposed to the outside, a visually neat outer appearance may be achieved.

Effects obtainable from the present disclosure are not limited by the above mentioned effects, and other unmentioned effects can be clearly understood from the above description by those having ordinary skill in the technical field to which the present disclosure pertains.

### BRIEF DESCRIPTION OF THE DRAWINGS

FIG. 1 is a diagram illustrating a cloud system based on a 5G network according to an embodiment of the present disclosure.

FIG. 2 is a diagram for illustrating a configuration of a driving robot according to an embodiment of the present disclosure.

FIG. 3 is a front perspective view of a driving robot according to an embodiment of the present disclosure.

FIG. 4 is a rear perspective view of a driving robot according to an embodiment of the present disclosure.

FIG. 5 is an exploded perspective view of a driving robot according to an embodiment of the present disclosure.

FIG. 6 is an exploded perspective view of a lower portion of a driving robot according to an embodiment of the present disclosure.

FIG. 7 is a view showing a method for fastening a slide basket of a driving robot according to an embodiment of the present disclosure.

FIG. 8 is a view showing a top surface of a lower housing and a bottom surface of a slide basket 106 of a driving robot according to an embodiment of the present disclosure.

FIG. 9 is a view showing a groove of a driving robot according to an embodiment of the present disclosure.

FIG. 10 is an exploded view showing components located at a front side of a lower portion of a driving robot according to an embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A robot is a machine device capable of automatically performing a certain task or operation. The robot may be controlled by an external control device or may be embedded in the control device. The robot may perform tasks that are difficult for humans to perform, such as repeatedly processing only a preset operation, lifting a heavy object, performing precise tasks or a hard task in extreme environments.

In order to perform such tasks, the robot includes a driver such as an actuator or a motor, so that the robot may perform various physical operations, such as moving a robot joint.

Industrial robots or medical robots having a specialized appearance for specific tasks due to problems such as high manufacturing costs and dexterity of robot manipulation were the first to be developed.

Whereas industrial and medical robots are configured to repeatedly perform the same operation in a designated place, driving robots have recently been developed and introduced to the market. Robots for use in the aerospace industry may perform exploration tasks or the like on distant planets that are difficult for humans to directly go to, and such robots have a driving function.

In order to perform the driving function, the robot has a driver, wheel(s), a frame, a brake, a caster, a motor, etc. In order for the robot to recognize the presence or absence of surrounding obstacles and move while avoiding the surrounding obstacles, an evolved robot equipped with artificial intelligence has recently been developed.

Artificial intelligence refers to a technical field for researching artificial intelligence or a methodology for implementing the artificial intelligence. Machine learning refers to a technical field for defining various problems handled in the artificial intelligence field and for researching methodologies required for addressing such problems. Machine learning is also defined as an algorithm that improves performance of a certain task through continuous experience.

An artificial neural network (ANN) is a model used in machine learning, and may refer to an overall model having problem solving ability, which is composed of artificial neurons (nodes) that form a network by a combination of synapses. The artificial neural network (ANN) may be defined by a connection pattern between neurons of different layers, a learning process of updating model parameters, and an activation function of generating an output value.

The artificial neural network (ANN) may include an input layer and an output layer, and may optionally include one or more hidden layers. Each layer includes one or more neurons, and the artificial neural network (ANN) may include a synapse that interconnects neurons and other neurons.

In the artificial neural network (ANN), each neuron may output a function value of an activation function with respect to input signals received through synapses, weights, and deflection.

A model parameter may refer to a parameter determined through learning, and may include the weight for synapse connection and the deflection of neurons. In addition, the hyperparameter refers to a parameter that should be set before learning in a machine learning algorithm, and includes a learning rate, the number of repetitions, a mini-batch size, an initialization function, and the like.

The purpose of training the artificial neural network (ANN) may be seen as determining model parameters that minimize a loss function according to the purpose of the robot or the field of use of the robot. The loss function may be used as an index for determining an optimal model parameter in a learning process of the artificial neural network (ANN).

Machine learning may be classified into supervised learning, unsupervised learning, and reinforcement learning according to learning methods.

Supervised learning refers to a method for training the artificial neural network (ANN) in a state where a label for learned data is given. Here, the label may refer to a correct answer (or a resultant value) that should be inferred by the artificial neural network (ANN) when the learned data is input to the artificial neural network (ANN). Unsupervised learning may refer to a method for training the artificial neural network (ANN) in a state where a label for learned data is not given. Reinforcement learning may refer to a learning method in which an agent defined in the certain environment learns to select an action or sequence of actions that may maximize cumulative compensation in each state.

Among artificial neural networks, machine learning implemented as a deep neural network (DNN) including a plurality of hidden layers is also referred to as deep learning, and deep learning is a part of machine learning. Hereinafter, machine learning is used in a sense including deep learning.

Artificial intelligence (AI) technology is applied to the robot, so that the robot may be implemented as a guide robot, a autonomous driving robot, a cleaning robot, a wearable robot, an entertainment robot, a pet robot, and an unmanned aerial robot, etc.

The robot may include a robot control module for controlling operation thereof, and the robot control module may refer to a software module or a chip implemented in hardware.

By means of sensor information obtained from various types of sensors, the robot may acquire state information of the robot, may detect (recognize) the surrounding environment and the object, may generate map data, may determine a driving path and a driving plan, may determine a response to user interaction, or may determine a necessary operation.

The robot may perform the above-described operations using a learning model composed of at least one artificial neural network (ANN). For example, the robot may recognize the surrounding environment and object using a learning model, and may determine a necessary operation using the recognized surrounding environment information or object information. Here, the learning model may be directly learned from the robot or learned from an external device such as an AI server.

In this case, whereas the robot may perform a necessary operation by directly generating a result using the learning model, the robot may also perform an operation by transmitting sensor information to an external device such as an AI server and receiving the resultant information generated thereby.

The robot may perform autonomous driving through artificial intelligence. Autonomous driving refers to a technique in which a movable object such as a robot may autonomously determine an optimal path by itself and may move while avoiding collision with an obstacle. The autonomous driving technique currently being applied may include a technique in which the movable object (e.g., a robot) may travel while maintaining a current driving lane, a technique in which the movable object may travel while automatically adjusting a driving speed such as adaptive cruise control, a technique in which the movable object may automatically travel along a predetermined path, and a driving technique in which, after a destination is decided, a path to the destination is automatically set.

In order to perform autonomous driving, the movable object such as the robot may include a large number of sensors to recognize data of the surrounding situation. For example, the sensors may include a proximity sensor, an illumination sensor, an acceleration sensor, a magnetic sensor, a gyro sensor, an inertial sensor, an RGB sensor, an infrared (IR) sensor, a fingerprint recognition sensor, an ultrasonic sensor, an optical sensor, a microphone, a Lidar, a radar, and the like.

The robot may perform autonomous driving not only based on information collected by sensors, but also based on image information collected by an RGBC camera and an infrared (IR) camera and sound information collected through a microphone. In addition, the robot may travel based on information received through a user input unit. Map data, position information, and information about peripheral situations may be collected through a wireless communication unit. The collected information is requisite for autonomous driving.

Map data may include object identification information for various objects disposed in a space where the robot moves. For example, the map data may include object identification information for fixed objects such as a wall and a door, and other object identification information for movable objects such as a flowerpot and a desk. In addition, the object identification information may include a name, a type, a distance, a location, etc.

Therefore, the robot may essentially include sensors, various input units, a wireless communication unit, and the like to collect data that may be learned by artificial intelligence, and may perform optimal operations by synthesizing various types of information. The learning processor for performing artificial intelligence may perform learning by being mounted in a controller embedded in the robot, may transmit the collected information to a server, may perform learning through the server, and may retransmit the learned result to the robot, so that the robot may perform autonomous driving based on the learned result.

A robot equipped with artificial intelligence may collect the surrounding information even in a new place to implement the entire map, and a large amount of information about a place of the major activity zone may be accumulated, so that the robot may perform more accurate autonomous driving.

The robot may include a touchscreen or a button to receive a user input, and may receive a command by recognizing a user's voice. In order to convert a voice input signal into a character string, the processor may obtain information about the intention corresponding to the user input using at least one of a speech to text (STT) engine for converting a voice input into a character string and a natural language processing (NLP) engine for obtaining information about the intention of natural language.

In this case, at least one of the STT engine and the NLP engine may include an artificial neural network (ANN) trained by a machine learning algorithm. In addition, at least one of the STT engine and the NLP engine may be trained by the learning processor, may be trained by the learning processor of the AI server, or may be trained by distributed processing of the trained results.

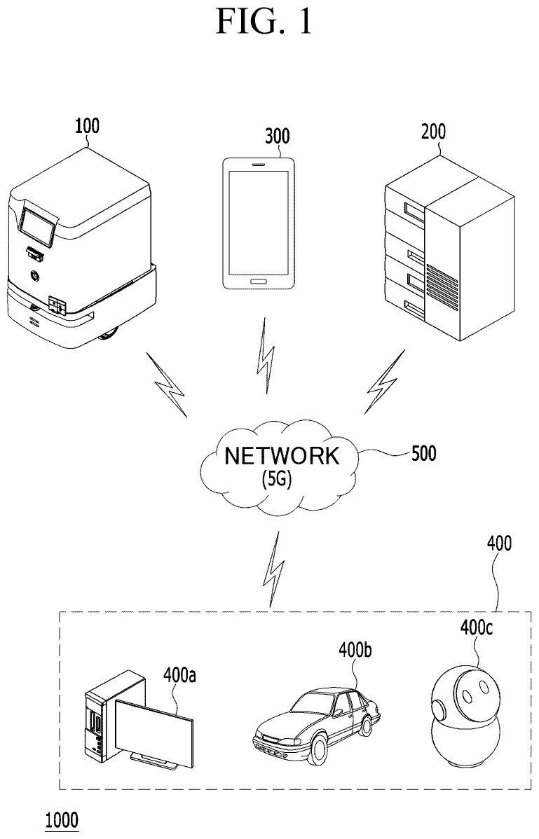

FIG. 1 is a diagram illustrating a cloud system 1000 based on a 5G network according to an embodiment of the present disclosure.

Referring to FIG. 1, the cloud system 1000 may include a driving robot 100, a mobile terminal 300, a robot control system 200, various devices 400, and a 5G network 500.

The driving robot 100 is a robot that transports goods (articles) from a departure point to a destination. If the driving robot 100 is a transport robot that delivers goods, it can move directly from a logistics center to a destination. Alternatively, after the driving robot is loaded on a vehicle at the logistics center and is then delivered to the vicinity of the destination by the vehicle, the driving robot is unloaded from the vehicle and then moves to the destination.

In addition, the driving robot 100 may move articles to the destination not only outdoors but also indoors. The driving robot 100 can be implemented as an AGV, and the AGV may be a transport device that moves by a sensor, a magnetic field, a vision device, etc. on the floor.

When the driving robot 100 is a serving robot that transports food, it should safely transport a bowl while avoiding fixed obstacles such as a table and people indoors. There is a tray for seating the bowl, and unlike a transport robot, a cover is omitted so as to easily put in and take out the bowl.

In addition, because the bowl has an open top, the driving robot 100 should be able to travel smoothly to operate more stably than the transport robot for a case in which the bowl tilts or falls.

The mobile terminal 300 may communicate with the driving robot 100 via the 5G network 500. The mobile terminal 300 may be a device carried by a user who installs a partition in the storage area to load articles, or may be a device carried by a recipient of the loaded articles. The mobile terminal 300 may provide information based on images, and the mobile terminal 300 may include mobile devices such as a mobile phone, a smartphone, a wearable device (e.g., a watch-type terminal, a glass-type terminal, an HMD).

The robot control system 200 may remotely control the driving robot 100 and respond to various requests of the driving robot 100. For example, the robot control system 200 may perform calculations using artificial intelligence (AI) based on the request from the driving robot 100.

In addition, the robot control system 200 may determine a movement path of the driving robot 100. When there is a plurality of destinations, the robot control system 200 may determine the order of the destinations when there are multiple destinations.

The various devices 400 may include a personal computer (PC) 400a, an autonomous vehicle 400b, a home robot 400c, etc. When the driving robot 100 arrives at the transport destination of the articles, the driving robot 100 can directly deliver the articles to the home robot 400c through communication with the home robot 400c.

The various devices 400 may be connected to the driving robot 100, the mobile terminal 300, the robot control system 200, etc., via the 5G network 500 by wire or wirelessly.

The driving robot 100, the mobile terminal 300, the robot control system 200, and various devices 400 are all equipped with 5G modules to transmit and receive data at a rate of 100 Mbps to 20 Gbps (or higher), so that large video files can be transmitted to various devices, and power consumption can be minimized by operating at low power. However, the transfer rate may be implemented differently depending on the embodiments.

The 5G network 500 may include a 5G mobile communication network, a short-range network, the Internet, etc., and may provide a communication environment for devices by wire or wirelessly.

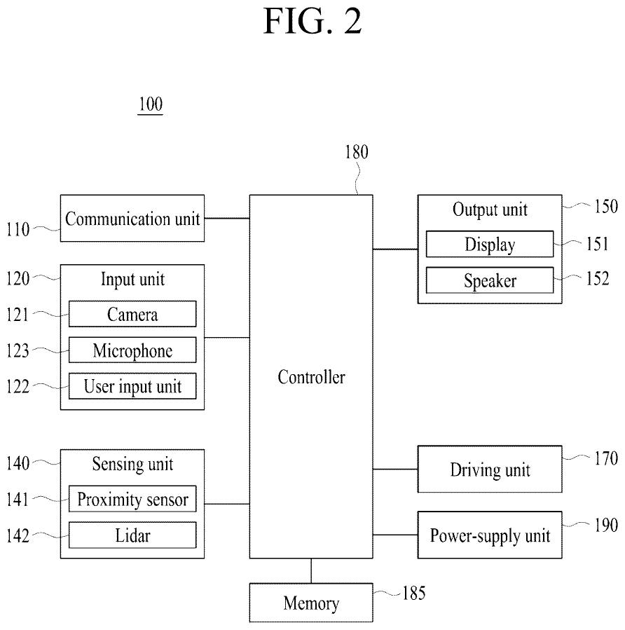

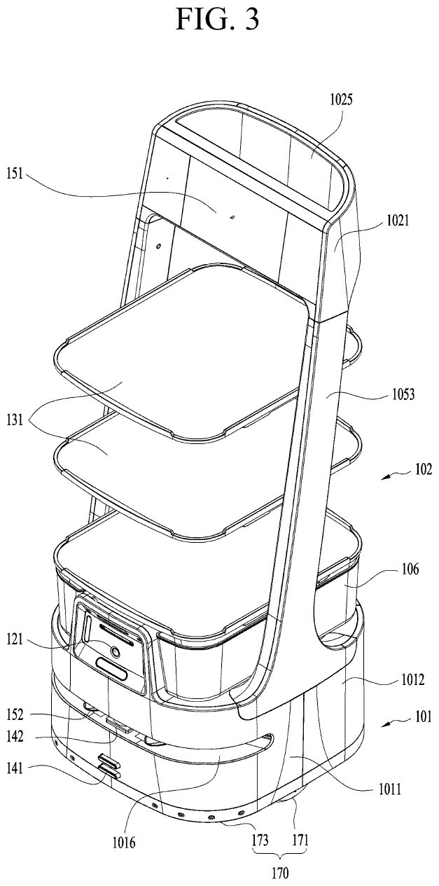

FIG. 2 is a diagram illustrating appearance of the driving robot 100 according to an embodiment of the present disclosure. The driving robot 100 according to an embodiment of the present disclosure will be described with reference to FIGS. 3 to 5.

Referring to FIG. 2, the driving robot 100 may include a body including a storage area 50, and constituent components to be described later may be included in the body. The driving robot 100 may include a communication unit 110, an input unit 120, a sensor unit 140, an output unit 150, a memory 185, a wheel driving unit 170, a controller 180, and a power-supply unit 190. The constituent components shown in FIG. 2 are not always required to implement the driving robot 100, such that it should be noted that the driving robot 100 according to the present disclosure may include more or fewer components than the elements listed above.

The communication unit 110 may include a wired or wireless communication module capable of communicating with the robot control system 200.

As an optional embodiment, the communication unit 110 may be equipped with modules for GSM, CDMA, LTE, 5G, WLAN, Wi-Fi, Bluetooth, RFID, infrared communication (IrDA), ZigBee, and NFC communication.

The input unit 120 may include a user input unit 122 for receiving information from a user. As an optional embodiment, the input unit 120 may include a camera 121 for inputting an image signal, and a microphone 123 (hereinafter referred to as a “microphone”) for receiving an audio signal. Here, the camera 121 or the microphone 123 may be treated as a sensor, and a signal acquired from the camera 121 or the microphone 123 may be referred to as sensing data or sensor information.

The input unit 120 may acquire input data to be used when acquiring output data using learning data and a learning model for model learning. The input unit 120 may obtain unprocessed input data. In this case, the controller 180 may extract input feature points as preprocessing for the input data.

The camera 121 may be located in front to detect obstacles in front, and as shown in FIG. 3, a plurality of cameras 121 may be arranged to be different in angle. In more detail, the plurality of cameras 121 may have different capture directions, such as a camera for widely recognizing a front-view area and a camera for capturing a floor.

Alternatively, cameras with different functions may be provided. For example, a wide-angle camera, an infrared (IR) camera, etc. may be provided. The camera may serve as a sensor unit 140 for detecting surrounding objects.

The user input unit 122 may be provided with a touch panel overlapping with a button or a display 151. Alternatively, a user command may be input remotely through the communication unit 110. In this case, the user input unit 122 may include a PC 400 or a remote control device separately provided from the driving robot 100.

Since the user input unit 122 includes all methods capable of receiving user commands, the user input unit 122 can recognize user commands through voice recognition. That is, a voice recognition device that analyzes voice collected from the microphone 123 and extracts user commands can also serve as the user input unit 122.

The input unit 120 may include an article information input unit, and the article information input unit may receive information about the article's size, information about the article's weight, destination information, information about a transport requester, etc. At this time, the article information input unit may include a code reader.

The sensor unit 140 may obtain at least one of internal information of the driving robot 100, surrounding environment information of the driving robot 100, and user information using various sensors.

At this time, the sensor unit 140 may include various types of sensors for recognizing the surroundings for autonomous driving. Representative examples may include a distance detection sensor or a proximity sensor 141 and a Lidar 141.

The proximity sensor 141 may include an ultrasonic sensor that recognizes nearby objects and determines the distance to the objects based on the time taken for emitted ultrasonic waves to return. A plurality of proximity sensors may be provided along the circumference, and may also be provided on an upper side to detect obstacles located on the upper side.

The Lidar 142 is a device that precisely expresses exterior appearances of the surroundings by emitting laser pulses and receiving the light that is reflected from the surrounding objects. The operation principle of the Lidar 142 is similar to that of a radar, but different electromagnetic waves are used in the Lidar 142 and the radar, so that the Lidar 142 and the radar are designed to use different technologies and different utilization ranges.

Lasers may damage human eyesight because they use light with a wavelength of 600 to 1000 nm. The Lidar 142 uses a longer wavelength than the lasers, and is used to measure not only the distance to a target object, but also a moving speed and direction, temperature, surrounding atmospheric material analysis, a concentration measurement, and the like.

In addition, the sensor unit 140 may include an illumination sensor, an acceleration sensor, a magnetic sensor, a gyro sensor, an inertial sensor, an RGB sensor, an infrared (IR) sensor, a fingerprint recognition sensor, an ultrasonic sensor, a light sensor, an optical sensor, etc.

The output unit 150 may generate various output signals related to visual, auditory and/or tactile sensations. The output unit 150 may include an optical output unit that outputs visual information, a display 151, etc. The output unit 150 may include a speaker 152 for outputting auditory information, an ultrasonic output unit for outputting ultrasonic signals belonging to an inaudible frequency, etc., and a haptic module for outputting tactile information.

The memory 185 may store data that supports various functions of the driving robot 100. The memory 185 may store not only a plurality of application programs (or applications) driven by the driving robot 100, but also data and commands required to operate the driving robot 100.

In addition, the memory 185 may store information required to perform operations using artificial intelligence, machine learning, and artificial neural networks. The memory 185 may store a deep neural network model. The deep neural network model may be used to infer a result value for new input data rather than learning data, and the inferred value may be used as a basis of determination required to perform a certain operation.

The power-supply unit 190 may receive external power or internal power under control of the controller 180, such that the power-supply unit 190 may supply the received power to the constituent components included in the driving robot 100. The power-supply unit 190 may include, for example, a battery. The battery 191 may be implemented as an embedded battery or a replaceable battery. The battery may be charged by a wired or wireless charging method, and the wireless charging method may include a magnetic induction method or a magnetic resonance method.

The driving unit 170 is a means for moving the driving robot 100, may include wheels or legs, and may include a wheel driving unit and a leg driving unit for controlling the wheels or legs. A plurality of wheels provided on the bottom surface of the wheel driving unit may be controlled to move the driving robot 100 including the body. The wheels may include a main wheel 171 for fast driving, a caster 173 for changing the direction to another direction, and an auxiliary caster for stable driving so that the loaded articles (L) do not fall during driving.

The leg driving unit (not shown) may control multiple legs according to control of the controller 180, and may thus move the body. The plurality of legs may correspond to a configuration formed so that the driving robot 100 can walk or run. The plurality of legs may be implemented as four legs, but the scope of the present disclosure is not limited thereto. The plurality of legs may be coupled to the body to be integrally formed, and may be implemented to be detachably coupled to the body.

The driving robot 100 may move the body through the driving unit 170 having at least one of the wheel driving unit and/or the leg driving unit. However, in this specification, an example in which the wheel driving unit is mounted on the driving robot 100 will be mainly described.

The controller 180 is a module that controls the configurations of the driving robot 100. The controller 180 may refer to a data processing device embedded in hardware that has a physically structured circuit to perform a function expressed by code or commands included in a program. As an example of the data processing device embedded in hardware, this exemplary data processing device may include processing devices such as a microprocessor, a central processing unit (CPU), a processor core, a multiprocessor, an ASIC, and an FPGA, but the scope of the present disclosure is not limited thereto.

The driving robot 100 may include a loading area 50 in a main body, and the loading area 50 may include a side wall or cover 10 to protect the loaded article from falling. Referring to FIG. 3, it is illustrated that the cover 10 is disposed, but a form in which only the side wall is disposed while omitting a top surface is also possible.

The loading area 50 does not have a separate layer division in the drawing, but it may be composed of a plurality of layers to load a plurality of articles in the layers. After unloading an article L on a lower side, an article on an upper side may be moved to a lower layer and additionally unloaded.

The controller 180 may collect at least one of number information, weight information, size information, delivery order information, and security level information of the articles L to be disposed in the loading area 50. For example, the controller 180 may collect the information via the input unit 120. The input of the input unit 120 may also include a touch input on the display.

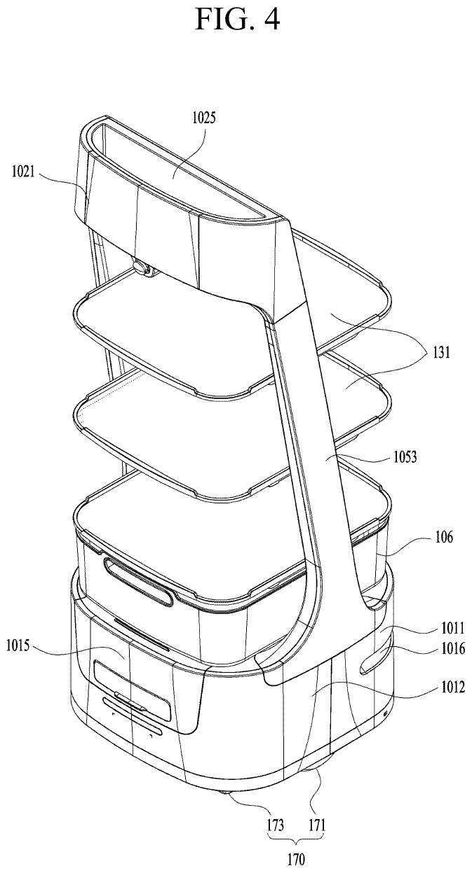

Based on the collected information, the controller 180 may transmit information on the articles (L) loaded in the loading area 50 to the mobile terminal 200 (see FIG. 1) through the communication unit 110. FIG. 3 is a front perspective view of the driving robot 100 according to an embodiment of the present disclosure, and FIG. 4 is a rear perspective view of the driving robot 100 according to an embodiment of the present disclosure.

A lower portion 101 of the driving robot 100 of the present disclosure, which is equipped with the driving unit 170, a substrate module 181, the battery 191, and the like, may be applied to all robots equipped with a travel function, such as a serving robot, a transport robot, or a sterilization robot.

However, for convenience of description, the description will be made based on the serving robot equipped with a tray module 131 at an upper portion as shown in FIGS. 3 and 4, but it may also be applied to other types of autonomous driving robots 100.

Referring to FIG. 3, the driving robot 100 may be divided into the lower portion 101 and an upper portion 102. The lower portion 101 may include a frame assembly 104 for mounting electronic components, and the driving unit 170 located under the frame assembly 104 and responsible for the movement of the driving robot 100.

The electrical components mounted on the frame assembly 104 include the substrate module 181, which is an assembly of a plurality of ICs and a substrate, as a controller that controls the driving robot 100. In addition, the battery 191 that supplies power, various sensors for assisting the travel, the camera 121, and the like may be mounted. The speaker 152, an LED lamp, or the like for output may be mounted.

The display 151 may be in charge of touch input and visual output. Because the touch input is performed by hand and the visual output is recognized by eyes, the display 151 is disposed at the upper portion 102 considering a user's height.

Most of the electrical components except for the display 151 may be located at the lower portion 101. The lower portion 101 may include a lower housing 1011, 1012, 1013, 1014, and 1015 forming an outer appearance thereof, and the lower structure 101 may have a cylindrical or rectangular box shape.

As shown in FIG. 3, the lower structure 101 may be formed to have a height smaller than a width to secure stability when the driving robot 100 travels. When the bowl or the article is seated on the tray module 131, which is the upper portion 102, a center of gravity may move upward, so that most of the electronic components may be placed at the lower portion 101 to lower the center of gravity.

The frame assembly 104 of the lower portion 101 may be made of a metal material, so that a weight of the lower portion 101 may be greater than that of the upper portion. To secure greater weight of the lower portion 101, a weight may be added on the lower portion 101.

The Lidar 142, the camera 121, the proximity sensor, and the like may be disposed at a front portion of the lower portion 101. Because the Lidar 142 has a wide sensing angle, the Lidar 142 may be seated in a groove 1016 that is recessed rearward from a front surface as shown in FIG. 3. The groove 1016 may have a horizontally elongated shape and may have a shape that is recessed rearward by about ⅓ of a depth when viewed from the side.

Even when water pours from above, water is not directly introduced into the groove 1016, so that a failure of the Lidar 142 located inside the groove 1016 resulted from submergence may be prevented from occurring. In addition to the Lidar 142, electronic components that should be exposed to the outside, such as the speaker 152 and a heat dissipation fan 187, may be disposed in the groove 1016 to further secure durability.

The camera 121 may be positioned at a front side of a top surface of the lower portion 101. The driving robot 101 may be equipped with a plurality of cameras arranged at different angles to recognize the object in a wide range. That is, the camera 121 may include at least one of a first camera 121 facing forward, a second camera 121 obliquely inclined upward, and a third camera 121 obliquely inclined downward.

The driving unit 170 positioned beneath the lower portion 101 may include a plurality of wheels, and more specifically, may include the main wheel 171 including a motor 1715 providing a traveling force, and a caster 173 that controls a direction and enhances travel safety.

The main wheel 171 may receive rotational power centered on a shaft of the motor extended laterally and travel, and a caster body 1732 to which a caster wheel 1731 is connected may be coupled to the lower portion 101 to be rotatable about a shaft 1736 extending vertically.

The upper portion 101 includes a tray frame 1055 extending upward from the lower housing and the tray module 131 coupled to the tray frame 1055. To stably support the tray module 131, a pair of tray frames 1055 may extend upward on both left and right sides, and the tray module 131 may be supported by tray holders 133 coupled onto the tray frames 1055 on both sides.

As illustrated in FIG. 3, a plurality of tray modules 131 may be included. The tray frame 1055 is inclined obliquely rearward, and a front space of the tray frame 1055 is secured relatively wide, making it easier to put in and take out the bowl.

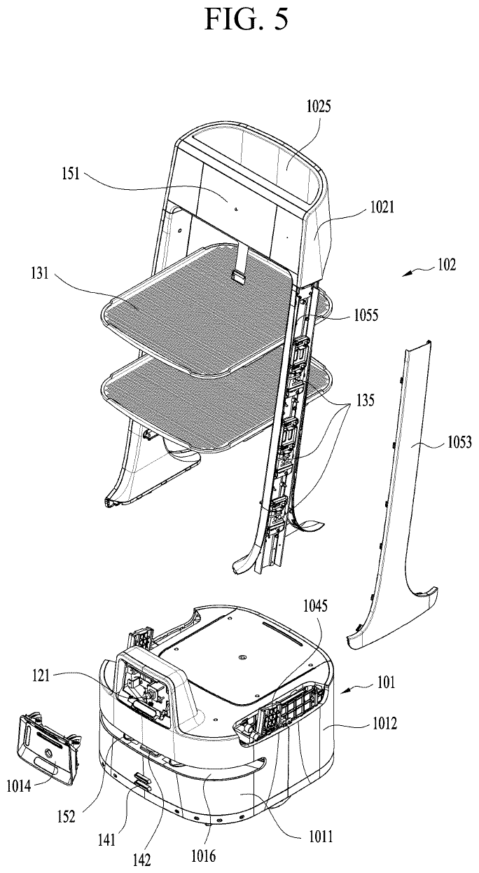

Upper ends of the pair of tray frames 1055 may include a head frame 1021 where they are connected to each other. The display 151 described above may be located at a front side of the head frame 1021. The electronic components other than the display 151 are not located at the head frame 1021, so that an upper basket 1025 may be disposed as shown in FIG. 5.

Supplies such as wet tissues or toilet paper may be placed in the upper basket 1025, so that customers may easily take the supplies. Further, because the upper basket 1025 is a portion that is not contaminated by food broth or the like, the upper basket 1025 may be hygienically managed.

A slide basket 106 that is seated on the top surface of the lower housing may be further disposed. Because the slide basket 106 is supported by the top surface of the lower housing, the slide basket 106 may store relatively heavy articles such as empty bowls. The slide basket 106 has sufficient depth to prevent the broth or the like from spilling and is detachable from the driving robot 100 in a sliding scheme, making it convenient for transporting the article and cleaning.

The slide basket 106 may be located between the tray module 131 and the top surface of the lower housing. Although the tray module 131 is shown in the drawing as being located directly above the slide basket 106, the slide basket 106 may be disposed at a location spaced apart from the tray module 131 by a predetermined distance.

The tray frames 1055 are located on left and right sides of the slide basket 106, and a casing of the camera 121 in which the camera 121 is mounted is located in front of the slide basket 106, so that the slide basket 106 may only be withdrawn in a rearward direction and may not be easily withdrawn in other directions, so that stable travel is available.

A handle may be disposed at a rear side such that the slide basket 106 is easily pulled in the rearward direction.

FIG. 5 is an exploded perspective view of the driving robot 100 according to an embodiment of the present disclosure. The upper portion 101 may be separated from the lower portion 101, and when a side casing forming the outer appearance of the tray frame 1055 is removed, a connecting frame 1045 extending upward from the lower portion 101 and a fastening portion of the tray frame 1055 may be exposed. By removing a screw that fastens the connecting frame 1045 with the tray frame 1055, the upper portion 101 may be separated from the lower portion 101 as shown in FIG. 5.

Electronic components of the upper portion 101 may include a load cell 135 that senses weights of the display 151 and the tray module 131, and the electronic component may be connected to the substrate module 181, which is the controller located at the lower portion 101, by connecting a cable along the extension direction of the tray frame 1055.

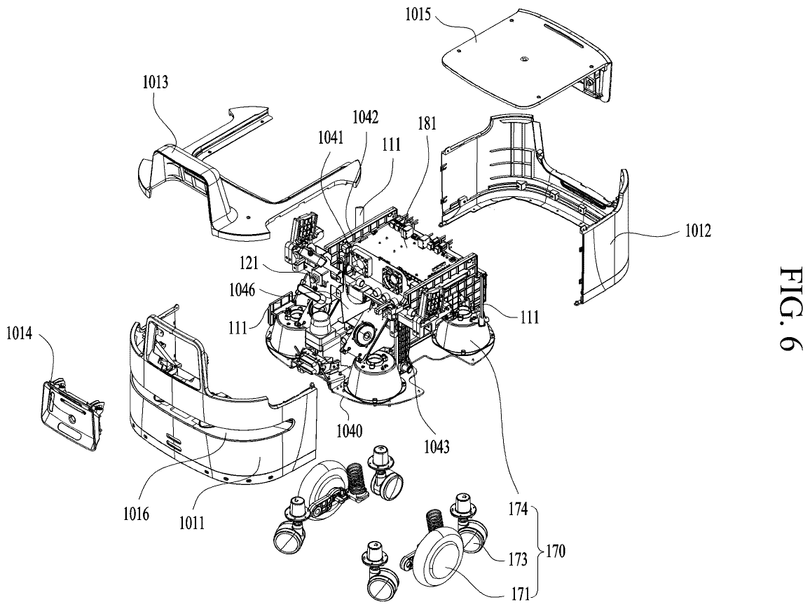

FIG. 6 is an exploded perspective view of the lower portion 101 of the driving robot 100 according to an embodiment of the present disclosure. The lower housing forming the outer appearance of the lower portion 101 may include a first casing 1011 positioned at a front surface of the lower portion, a second casing 1012 positioned at a rear surface of the lower portion, and a third casing 1013 forming a top surface of the lower portion.

The frame assembly 104, the driving unit 170, the substrate module 181, and the battery 191 may be mounted in an electrical component portion surrounded by the first casing 1011, the second casing 1012, and the third casing 1013.

A camera casing protruding from the front side of the lower portion 101 may be equipped as a separate casing independent of the first casing 1011 or the third casing 1013, or as illustrated in FIG. 6, a portion of the third casing 1013 may protrude to form the casing of the camera 121. Because a front side of the camera 121 is equipped with transparent glass that transmits light, a camera cover 1014 may be disposed separately as illustrated in FIG. 6.

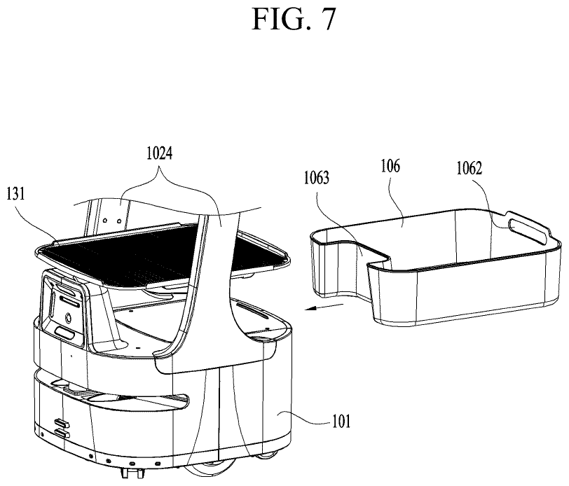

FIG. 7 is a view showing a method for fastening the slide basket 106 of the driving robot 100 according to an embodiment of the present disclosure.

The slide basket 106, which is seated on a top surface of the lower portion 101, may be pulled rearward to open a top surface thereof. A handle 1062 may be disposed on a rear surface of the slide basket 106 to facilitate pulling the slide basket 106.

Because the slide basket 106 is supported by the top surface of the lower portion 101, the slide basket 106 may load a relatively heavy article. Because the slide basket 106 is located at a lower portion of the driving robot 100, it may be inconvenient for a user to withdraw the slide basket 106, but because the slide basket 106 is completely detachable from the driving robot 100, the articles in the slide basket 106 may be removed at once.

The tray module 131 located on the top surface of the slide basket 106 may be directly attached to the slide basket 106 or may be spaced apart therefrom by a predetermined distance. The tray module 131 positioned on the slide basket 106 may fix a location of an upper portion of the slide basket 106, so that the slide basket 106 may be stably fixed to the driving robot 100.

To prevent the slide basket 106 from moving in a vertical direction when the tray module 131 is spaced apart from the slide basket 106, a basket holder 1065 to which a side portion of the slide basket 106 is fitted may be included on an inner side of the tray frame 1055. The slide basket 106 protrudes for a lateral upper portion of the slide basket 106 to be caught, thereby preventing the slide basket 106 from deviating upward.

A camera 121 casing for mounting the camera 121 may be disposed on a front surface of the slide basket 106. Accordingly, the slide basket 106 may have a concave portion 1063 corresponding to a shape of the camera 121 casing in the front surface thereof.

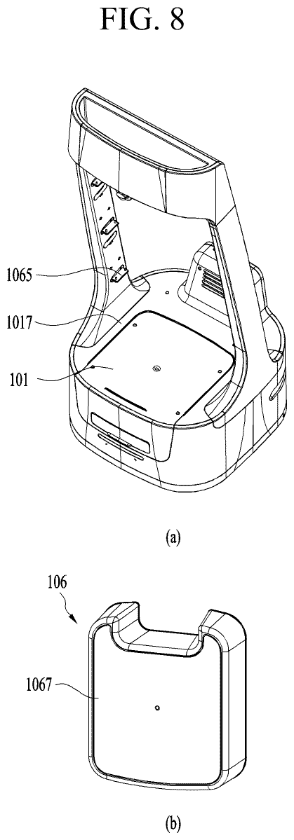

FIG. 8 is a view showing a top surface of the lower housing and a bottom surface of the slide basket 106 of the driving robot 100 according to an embodiment of the present disclosure.

When the slide basket 106 moves in a front and rear direction on the top surface of the lower portion 101, the third casing 1013 or the service cover 105 is worn out or the slide basket 106 is worn out.

To minimize a contact area between the slide basket 106 and the lower housing during the movement of the slide basket 106, wear prevention ribs 1017 and 1067 may be additionally disposed.

As shown in (a) in FIG. 8, the lower housing may be formed with the wear prevention rib 1017 protruding along an opening where the service cover 1015 is coupled or around a periphery of the service cover 1015.

As shown in (b) in FIG. 8, the wear prevention rib 1067 protruding along a periphery of the bottom surface of the slide basket 106 may be disposed.

In addition to the slide basket 106, an upper basket 1025 may be disposed at an upper portion by utilizing the head frame 1021. The upper basket 1025 in a form of a basket with a side wall may enable storage of the article without falling during traveling, and may store various types of articles.

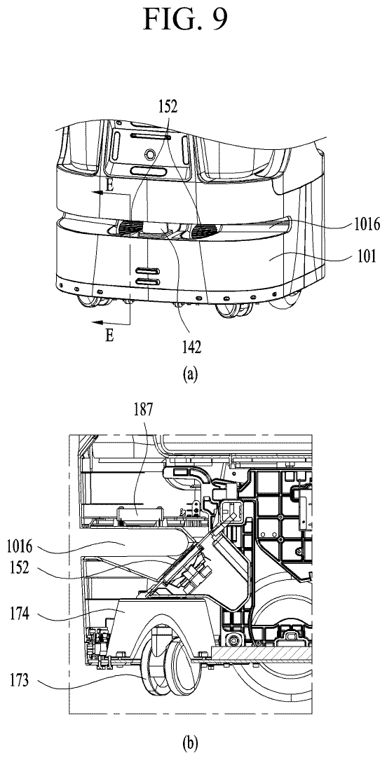

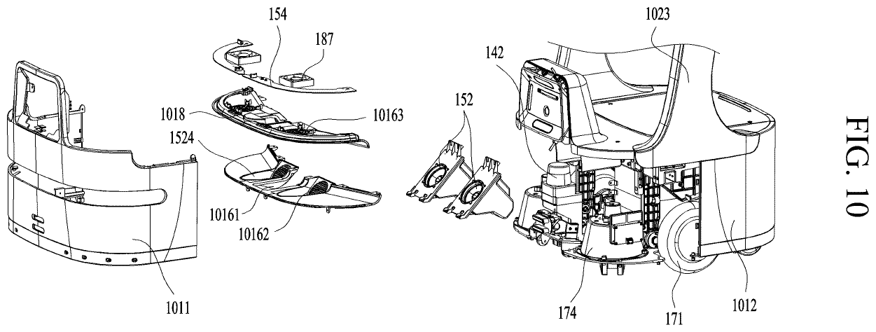

FIG. 9 is a view showing a groove 1016 of the driving robot 100 according to an embodiment of the present disclosure, and FIG. 10 is an exploded view showing components located at a front side of the lower portion 101 of the driving robot 100 according to an embodiment of the present disclosure.

(a) in FIG. 9 is a perspective view and (b) in FIG. 9 is a cross-sectional view taken along a line E-E, showing electronic components mounted in the groove 1016. As described above, the groove 1016 is the concave portion that is recessed rearward from the front surface of the lower portion 101. The groove 1016 has a slit shape that is extended horizontally, and is required to place the Lidar 142.

The Lidar 142 may analyze a distance to a surrounding object, a shape of the object, moving speed and direction of the object, a temperature of the object, and a surrounding atmospheric substance using reflection of laser pulses. In particular, the Lidar 142 may be used to implement a 3D image.

Because the Lidar 142 scans surroundings while rotating horizontally, the groove 1016 may have the form of extending to a side portion of the lower portion 101 such that the Lidar 142 may scan as wide a range as possible.

Even when water flows down from above the driving robot 100, water does not easily flow into the groove 1016, which is concavely recessed inward. By utilizing such characteristic, a component that should be exposed to the outside may be placed in the groove 1016 to prevent damage by water.

In the present embodiment, the speaker 152 may be disposed. The speaker 152 should have an opening defined for sound output, and a waterproof material that is impermeable to water, such as Gore-Tex, may be used for waterproofing. However, when using the waterproof material, holes of the waterproof material are dense, resulting in reduced output and sound quality.

When the speaker 152 is disposed inside the groove 1016 as shown in (a) in FIG. 9, water may be prevented from flowing into the speaker 152. The speaker 152 may be disposed on left and right sides of the Lidar 142, and may be disposed not to protrude as much as possible from an inner surface of the groove 1016 so as not to interfere with the scanning of the Lidar 142.

Referring to (b) in FIG. 9, the speaker 152 may be disposed in a form of facing upward obliquely such that the sound is output in an upward direction considering a height of a person.

Referring to FIG. 10, a groove cover 1018 forming a concave surface of the groove 1016 may be further included. The groove cover 1018 may include a first opening 10161 in which the Lidar 142 is disposed and a second opening 10162 in which the speaker 152 is disposed.

The second opening 10162 may include a mesh-type cover to protect a diaphragm of the speaker 152. When a size of the speaker 152 is greater than a vertical dimension of the groove 1016, as shown in (b) in FIG. 10, the speaker 152 may be disposed in a shape of being more concavely recessed in a bottom surface of the groove 1016 and an inclined surface may be formed on a front surface of the second opening 10162.

The inclined surface on the front surface of the speaker 152 naturally connects the second opening 10162 with a size greater than the vertical dimension of the groove 1016 based on the size of speaker 152 with the bottom surface of groove 1016, and plays a role in guiding the sound output from the speaker 152 upward.

The speaker 152 needs a support bracket at a bottom so as to be positioned at a certain vertical level from the base plate 1040. As shown in (b) in FIG. 9, in the present embodiment, the speaker 152 may be seated on a top surface of the caster housing 174 protruding upward from the base plate 1040 without the separate support bracket.

Various electronic components such as the substrate module 181 and the battery 191 are embedded inside the lower portion 101, and generate a lot of heat when operated for a long time. A heat dissipation hole is required to discharge the heat inside the lower portion 101, but the heat dissipation hole has a problem in waterproofing.

To prevent water from flowing into the heat dissipation hole, a third opening 10163 may be defined in the groove 1016 to discharge the heat inside the lower housing. To increase a heat dissipation effect, a dissipation fan 187 may be additionally disposed inside the third opening 10163.

Because a lower portion of the groove 1016 is formed with the inclined surface for the speaker 152, the third opening 10163 may be defined in a top surface of the groove 1016 and the dissipation fan 187 may be disposed in the third opening.

Water inflow to the third opening 10163 located in the top surface of the groove 1016 is further limited, so that the problem of moisture inflow via the heat dissipation hole may be minimized.

In addition, an LED light 154 may be disposed along a laterally extending cut surface of the groove 1016 to indicate a state of the driving robot 100 or as a light emitter for an aesthetic effect. The LED light 154 may be disposed on a substrate and may be located in front of the third opening 10163 of the groove.

As described above, the driving robot 100 of the present disclosure includes various types of storages 1025 and 106, so that usability may be improved.

In addition, the components with weak waterproofness may be disposed in the groove 1016 to minimize the water inflow.

Because the hole for the placement of the speaker 152 or for the heat dissipation is not exposed to the outside, a visually neat outer appearance may be achieved.

The above detailed description should not be construed as limiting in all respects, but should be considered illustrative. The scope of the present disclosure should be determined by a reasonable interpretation of the appended claims, and all changes within the equivalent scope of the present disclosure are included in the scope of the present disclosure.

What is claimed is:

1. A driving robot comprising:
a lower housing;
a frame assembly positioned inside the lower housing;
a driving structure positioned under the frame assembly;
a battery coupled to the frame assembly;
a substrate module coupled to the frame assembly and positioned above the battery;
a Lidar coupled to a portion in front of the frame assembly; and
a speaker module disposed adjacent to the Lidar,
wherein the lower housing includes:
a groove defined at a front side of the lower housing to extend in a left and right direction, wherein the groove is concavely recessed rearward;
a first opening defined in the groove and exposing the Lidar; and
a second opening located in front of the speaker module.

2. The driving robot of claim 1, wherein the driving structure includes:
a caster housing coupled to the frame assembly and having an open bottom; and
a caster positioned in the caster housing,
wherein the speaker is positioned on a top surface of the caster housing.

3. The driving robot of claim 2, wherein the second opening is obliquely inclined upward.

4. The driving robot of claim 3, further comprising a sound guide inclined surface located at a front surface of the second opening, wherein the sound guide inclined surface is disposed at a lower portion of the groove to be inclined downward in an inward direction.

5. The driving robot of claim 1, further comprising:
a third opening defined in a top surface of the groove; and
a dissipation fan formed inside the third opening.

6. The driving robot of claim 1, wherein the groove is recessed into a front surface of the lower housing by at least ⅓ of a length in a front and rear direction of the lower housing.

7. The driving robot of claim 1, further comprising:
a pair of tray frames coupled to an upper portion of the lower housing and extending upward; and
a tray module coupled to the tray frame.

8. The driving robot of claim 7, further comprising a slide basket inserted between the tray module and the lower housing.

9. The driving robot of claim 8, further comprising a scratch prevention rib protruding on at least one of a bottom surface of the slide basket and a top surface of the lower housing.

10. The driving robot of claim 8, further comprising a camera box protruding from a front portion of a top surface of the lower housing,
wherein the pair of tray frames are located on left and right sides of the slide basket,
wherein the slide basket has a handle formed at a rear surface thereof.

11. The driving robot of claim 7, further comprising:
a head frame connecting upper ends of the pair of tray frames to each other; and
an upper basket formed at the head frame.

12. The driving robot of claim 11, further comprising a display located on a front surface of the upper basket.

13. A driving robot comprising:
a lower housing;
a frame assembly positioned inside the lower housing;
a driving structure positioned under the frame assembly;
a battery coupled to the frame assembly;
a substrate module coupled to the frame assembly and positioned above the battery;
a pair of tray frames coupled to an upper portion of the lower housing and extending upward;
a tray module coupled to the tray frames; and
a slide basket inserted between the tray module and the lower housing.

14. The driving robot of claim 13, further comprising a scratch prevention rib protruding on at least one of a bottom surface of the slide basket and a top surface of the lower housing.

15. The driving robot of claim 13, further comprising a camera box protruding from a front portion of a top surface of the lower housing,
wherein the pair of tray frames are located on left and right sides of the slide basket,
wherein the slide basket has a handle formed at a rear surface thereof.

16. The driving robot of claim 13, further comprising:
a head frame connecting upper ends of the pair of tray frames to each other; and
an upper basket formed at the head frame.
